(19) United States
(12) Patent Application Publication
(10) Pub. No.: US 2010/0075200 A1
(43) Pub. Date: Mar. 25, 2010

(54) HIGH-PRESSURE TANK, METHOD OF MANUFACTURING HIGH-PRESSURE TANK, AND MANUFACTURING EQUIPMENT OF HIGH-PRESSURE TANK

(76) Inventor: Ken HATTA, Okazaki-shi (JP)

Correspondence Address: KENYON & KENYON LLP, 1500 K STREET N.W., SUITE 700, WASHINGTON, DC, 20005, US

(21) Appl. No.: 12/564,433

(22) Filed: Sep. 22, 2009

(30) Foreign Application Priority Data
Sep. 22, 2008 (JP) 2008-242444

(51) Int. Cl. H01M 2/00; B29C 65/00; F17C 1/02

(52) U.S. Cl. 429/34; 156/245; 425/358; 220/586

(57) ABSTRACT

A high-pressure tank including: a cap; a liner; and a reinforced layer that is provided on the liner. The liner includes a gas barrier layer.

### INCORPORATION BY REFERENCE

The disclosure of Japanese Patent Application No. 2008-242444 filed on Sep. 22, 2008 including the specification, drawings and abstract is incorporated herein by reference in its entirety.

### BACKGROUND OF THE INVENTION

1. Field of the Invention

The present invention relates to a high-pressure tank, a method of manufacturing the high-pressure tank, and manufacturing equipment of the high-pressure tank. More specifically, the present invention relates to an improvement in the structure of a high-pressure tank, a suitable method of manufacturing the high-pressure tank with the improved structure, and manufacturing equipment of the high-pressure tank with the improved structure.

2. Description of the Related Art

A high-pressure tank (high-pressure gas storage container) used for storing or supplying hydrogen and the like is known that includes: a tank body that has a liner in which the outer peripheral surface is impregnated with resin and reinforced with a carbon fiber reinforced plastics (CFRP) layer, for example; and a cap that is made of alloy and attached to the opening of the tank body. For example, a valve assembly (a part that includes a high-pressure valve and the like) may be attached to the cap that is provided in a tank opening. Also disclosed is a high-pressure tank with a structure in which a metal layer is formed on the inner surface of a resin liner so as to reduce an amount of permeated hydrogen (see Japanese Patent Application Publication No. 2006-316934 (JP-A-2006-316934), for example).

However, when the metal layer is formed on the inner surface of the liner as in the high-pressure tank described above, there is a possibility of detachment of the metal layer at high pressure.

In order to solve such a problem, the inventor has made various deliberations. In the high-pressure tank with a two-layer structure that is formed from the liner and a CFRP layer, a trace amount of hydrogen gas may permeate through the liner layer and be accumulated between the liner layer and the CFRP layer. In this case, because a space between the CFRP layer and the cap is pressure-sealed when the inside the tank is at high pressure, hydrogen gas remains accumulated between the liner layer and the CFRP layer. However, when the inner pressure of the tank decreases with use of hydrogen gas and the like, there occurs a phenomenon that hydrogen gas leaks outside the tank from the weakly sealed space between the CFRP layer and the cap. After the deliberation on high-pressure tanks, particularly on the phenomenon that hydrogen gas permeates through the liner layer, the inventor has reached a new finding that links to a solution for the problem.

### SUMMARY OF THE INVENTION

The present invention provides a high-pressure tank that reduces an amount of hydrogen that permeates through a liner without adopting a structure in which a metal layer is formed on the inner surface of the liner, and also provides a method of manufacturing the high-pressure tank and manufacturing equipment of the high-pressure tank.

A first aspect of the present invention relates to a high-pressure tank that includes a cap, a liner, and a reinforced layer that is provided on the liner. The liner includes a gas barrier layer.

In the above aspect, the gas barrier layer may be formed on the outer surface of the liner.

For example, EVOH that forms the gas barrier layer is a resin material that resists gas permeation. Therefore, according to the above aspect, it is possible to prevent gas permeation through the liner in the high-pressure tank. Meanwhile, there is a case where mixture of EVOH and the liner resin causes a chemical reaction, thereby degrading the physical property of the liner. Consequently, the tank cannot maintain its strength. However, according to the above aspect, when the two-layer structure is made by forming the EVOH layer on the resin liner (first layer), for example, there is no possible occurrence of a chemical reaction between EVOH and the liner resin. In addition, since it is possible to prevent gas permeation without forming the metal layer, there is no detachment of the metal layer at high pressure. The gas barrier layer that is formed on the outer surface of the liner is interposed between the resin liner and the reinforced layer formed from CFRP, for example.

A second aspect of the present invention relates to a method of manufacturing a high-pressure tank. The method of manufacturing the high-pressure tank includes: injecting resin into a forming mold that includes from a male mold and a first female mold, and forming a first layer of a liner; removing the first female mold and replacing it with a second female mold; injecting resin with a gas barrier property to form a gas barrier layer on the outer surface of the first layer so as to make a two-layer structure;

welding the liners to each other after the two-layered liner is released from the mold; and heating and curing the welded liners after filament winding molding.

According to the above aspect, following the forming of the first layer of the liner, the gas barrier layer can be formed without releasing the first layer of the liner from the male mold. Thus, it is possible to manufacture the high-pressure tank in which gas permeation through the liner is prevented. In addition, by sharing the male mold to form the two-layered liner, it is possible to simplify processes, reduce process time, and reduce cost.

A third aspect of the present invention relates to a method of manufacturing a high-pressure tank. The method of manufacturing the high-pressure tank includes: forming a resin film that is made of a resin material with a gas barrier property into a specified shape in advance; injecting resin into a forming mold that includes a male mold and a female mold, and forming a first layer of a liner; placing the resin film to the inside of the female mold or the outer surface of the first layer after the male mold and the female mold are separated; forming a gas barrier layer on the outer surface of the first layer by film insert molding so as to make a two-layer structure; welding the liners to each other after the two-layered liner is released from the mold; and heating and curing the welded liners after filament winding molding.

A forth aspect of the present invention relates to manufacturing equipment of a liner for a high-pressure tank. The manufacturing equipment of the liner for the high-pressure tank includes: a male mold to form the liner; a first female mold that creates a space between the first female mold and the male mold to form a first layer of the liner; and a second female mold with which the first female mold is replaced after the first layer is formed, and that creates a space to form a gas barrier layer on the outer surface of the first layer.

According to the above aspect, following the forming of the first layer of the liner, the gas barrier layer (e.g., an EVOH layer) can be formed without removing the first layer from the male mold. Thus, it is possible to form the liner that prevents gas permeation therethrough. In addition, by sharing the male mold to form the two-layered liner, it is possible to simplify processes, reduce process time, and reduce cost.

According to the above aspects, it is possible to reduce the amount of permeated hydrogen through the liner by adopting a structure other than the structure in which a metal layer is formed on the inner surface of the liner.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 shows a configuration example of a fuel cell system in an embodiment of the present invention;

FIG. 2 is a cross sectional view that shows main components of a high-pressure tank according to the embodiment of the present invention;

FIG. 3 shows an injection molding process of a first layer of a liner in the embodiment of a method of manufacturing the high-pressure tank;

FIG. 4 shows a state where a first female mold is opened after the injection molding process;

FIG. 5 shows an extrusion molding process of an EVOH layer of the liner in the embodiment of the method of manufacturing the high-pressure tank;

FIG. 6 is a plan view that shows a configuration example of manufacturing equipment of the liner for the high-pressure tank according to the present invention;

FIG. 7 shows a state where open ends of two resin liners are abutted against and welded to each other;

FIG. 8 is a perspective view that shows an example of the high-pressure tank after FW molding;

FIG. 9 shows the injection molding process of the first layer of the liner in a second embodiment of the present invention;

FIG. 10 shows a state where a female mold is opened and split after the injection molding process;

FIG. 11 shows a process in which a resin film made of EVOH is pressure-formed on the outer surface of the resin liner;

FIG. 12A is a general view of the high-pressure tank;

FIG. 12B is a partially enlarged view that shows a state where hydrogen gas that has penetrated through the resin liner is accumulated between the resin liner and an outer reinforced layer (CFRP layer) for reference;

FIG. 13 shows a state where the resin liner is deformed inwardly when hydrogen gas is discharged for reference; and

FIG. 14 shows a state where hydrogen gas that has permeated through the resin liner is accumulated between the resin liner and the outer reinforced layer (CFRP layer).

### DETAILED DESCRIPTION OF AN EMBODIMENT

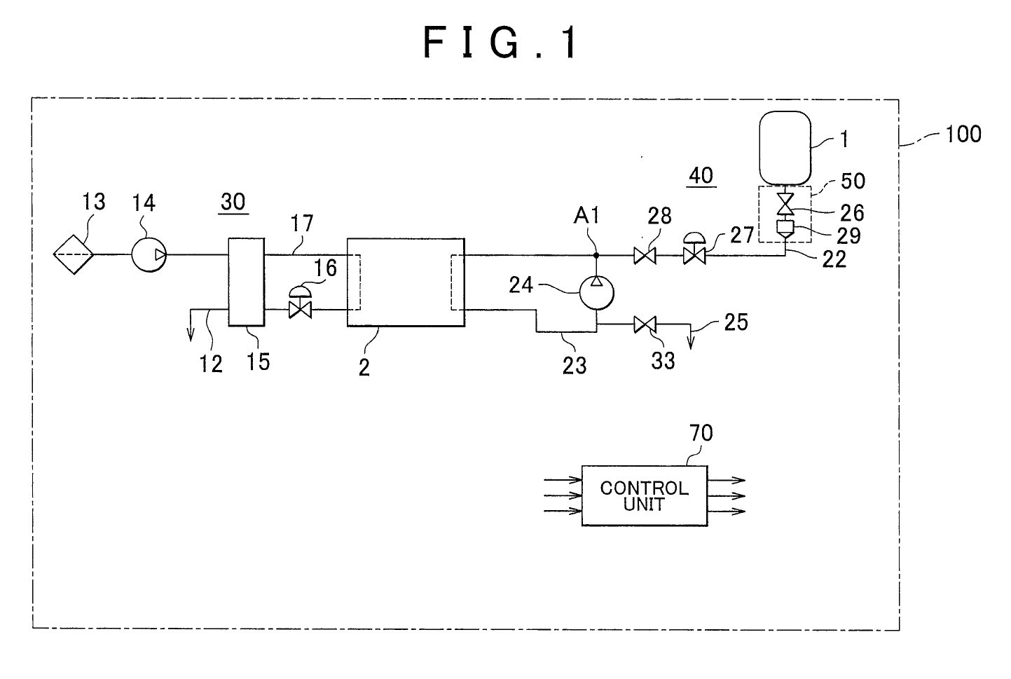

The construction of the present invention will hereinafter be described in detail on the basis of an embodiment shown in the drawings. FIG. 1 to FIG. 14 show a high-pressure tank and a manufacturing method thereof according to the embodiment of the present invention. A high-pressure tank 1 includes a cap 11, a resin liner (liner) 20, and a carbon fiber reinforced plastics (CFRP) layer (reinforced layer) 21 that is provided on the outer periphery of the resin liner 20. A description will hereinafter be made in a case where the high-pressure tank 1 according to the embodiment is applied to a high-pressure hydrogen tank as a fuel supply source in a fuel cell system 100.

The general construction of the fuel cell system in this embodiment (see FIG. 1) will be described first. The fuel cell system 100 includes: a fuel cell 2; an oxidation gas piping system 30 that supplies air (oxygen) to the fuel cell 2; a fuel-gas piping system 40 that supplies hydrogen gas to the fuel cell 2; and a control unit 70 that controls the overall system.

The fuel cell 2 is constructed from a solid polyelectrolyte and has a stack structure in which a number of unit cells are laminated. The unit cells of the fuel cell 2 each have an air cathode on one surface of an electrolyte that is formed from an ion-exchange membrane, a fuel anode on the other surface of the electrolyte, and a pair of separators that sandwiches the air cathode and the fuel anode. The fuel gas is supplied into a fuel gas flow passage in one of the separators while oxidation gas is supplied into an oxidation gas flow passage in the other of the separators. The fuel cell 2 produces electricity from the supplied gases.

The oxidation gas piping system 30 has: a supply passage 17 through which oxidation gas to be supplied to the fuel cell 2 flows; and a discharge passage 12 through which oxidation off-gas that is discharged from the fuel cell 2 flows. The supply passage 17 is provided with a compressor 14 that receives oxidation gas through a filter 13, and a humidifier 15 that humidifies oxidation gas forcedly fed by the compressor 14. Oxidation gas, which flows through the discharge passage 12, passes through a back-pressure regulation valve 16 and is subjected to moisture exchange in the humidifier 15 before being discharged as exhaust gas to the atmosphere outside of the system.

The fuel gas piping system 40 has: the high-pressure tank 1 as a fuel supply source that is filled with high-pressure hydrogen; a supply passage 22 through which hydrogen gas to be supplied to the fuel cell 2 flows from the high-pressure tank 1; a circulation passage 23 for returning hydrogen-off gas (fuel-off gas) that is discharged from the fuel cell 2 to a confluence A1; a pump 24 that forcedly feeds hydrogen-off gas in the circulation passage 23 to the supply passage 22; and a discharge passage 25 that is branch-connected to the circulation passage 23.

The high-pressure tank 1 is preferred as a fuel gas supply tank for a fuel cell vehicle. Although not shown, three high-pressure tanks 1 are installed in the rear section of the vehicle, for example. The high-pressure tank 1 constitutes a part of the fuel cell system 100 and supplies fuel gas to the fuel cell 2 through the fuel gas piping system 40. The fuel gas that is stored in the high-pressure tank 1 may be high-pressure combustible gas such as hydrogen gas and compressed natural gas.

The high-pressure tank 1 in this embodiment is constructed such that hydrogen gas may be stored therein at pressure such as 35 MPa. When a main stop valve 26 of the high-pressure tank 1 is open, hydrogen gas flows into the supply passage 22. After the flow rate and pressure of hydrogen gas is adjusted by an injector 29, the pressure of hydrogen gas is eventually reduced to approximately 200 kPa, for example, by mechanical a pressure regulating valve 27 or other pressure reducing valve downstream from the injector 29. Then, hydrogen gas is supplied to the fuel cell 2. The main stop valve 26 and the injector 29 are embedded in a valve assembly 50 that is shown in a broken line box in FIG. 1. The valve assembly 50 is connected to the high-pressure tank 1.

A shutoff valve 28 is provided upstream of the supply passage 22 from the confluence A1. A circulation system of hydrogen gas is constructed by communicating a flow passage downstream of the confluence A1 in the supply passage 22, the fuel gas flow passage formed in one of the separators of the fuel cell 2, and the circulation passage 23 in the respective order. A purge valve 33 on the exhaust passage 25 is appropriately opened during the operation of the fuel cell system 100 so that impurities in hydrogen off-gas are discharged along with hydrogen off-gas into a hydrogen diluter (not shown). When the purge valve 33 is open, concentration of the impurities in hydrogen off-gas is reduced, and concentration of hydrogen in hydrogen off-gas, which is circulated for supply, is increased in the circulation passage 23.

The control unit 70 is constructed as a microcomputer that includes a CPU, a ROM, and a RAM. The CPU executes a desired calculation in accordance with a control program (programme) and performs various processing and controls such as flow rate control of the injector 29. The ROM stores the control program and control data processed by the CPU. The RAM is mainly used as various workspace for control processing. The control unit 70 receives various detection signals from a pressure sensor, a temperature sensor, and the like that are used in the gas systems (30 and 40) and a refrigerant system (not shown) and transmits the signals to each component.

Next, the structure of the high-pressure tank 1 will be described.

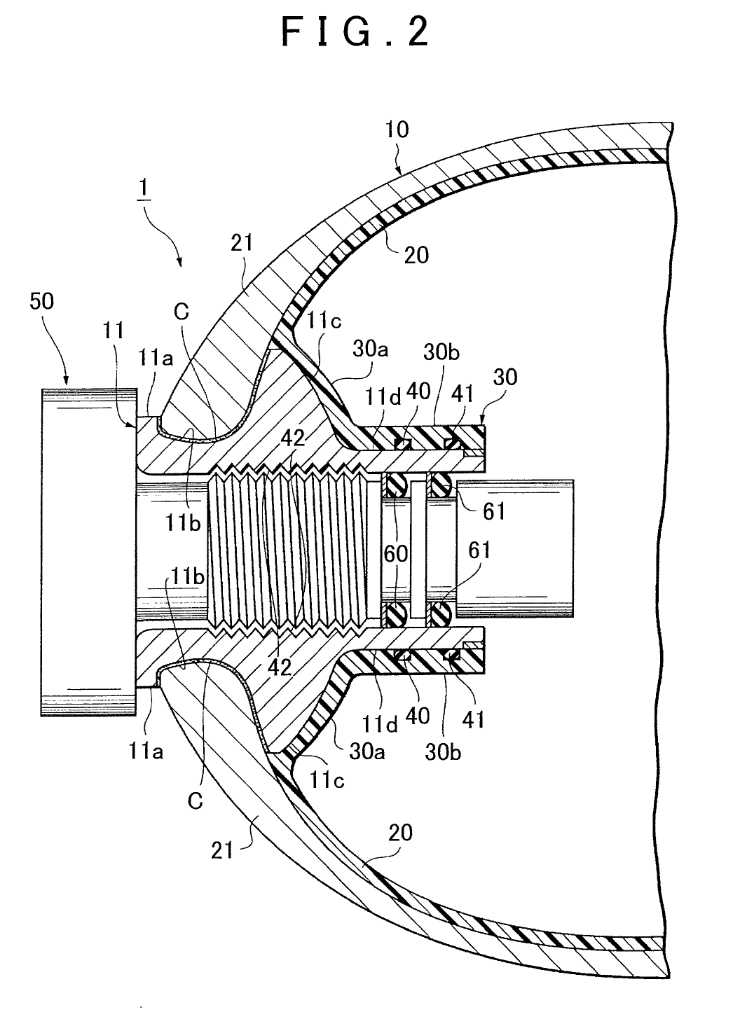

FIG. 2 is a sectional view that shows the main components of the high-pressure tank 1. The high-pressure tank 1 has a cylindrical tank body 10 with hemispherical ends, for example, and the cap 11 that is attached to one axial end of the tank body 10.

The tank body 10 has a two-layer wall structure, where the liner 20 is the inner wall layer and a resin filament layer (reinforced layer), such as the CFRP layer 21, is the outer wall layer.

The liner 20 is formed in the approximately same shape as the tank body 10. The liner 20 is formed from polyethylene resin, polypropylene resin, or other hard resin, for example (hereinafter, the liner 20 will also be referred to as the resin liner 20).

A tip side of the resin liner 20 with the cap 11 is formed with a folded portion 30 that is folded inwardly. The folded portion 30 is folded toward the inside of the tank body 10 so as to separate from the outer CFRP layer 21. The folded portion 30 has: a radius reduction portion 30a that gradually decreases in radius as it approaches the tip of the folded portion 30; and a cylindrical portion 30b that has a constant radius and is connected to a tip of the radius reduction portion 30a. An opening of the resin liner 20 is formed by this cylindrical portion 30b.

The cap 11 is generally cylindrical and fitted in the opening of the resin liner 20. For example, the cap 11 is made of aluminum (aluminium) or aluminum (aluminium) alloy and formed in a specified shape by a die casting method or the like. The cap 11 is attached to the resin liner 20 by insert molding, for example.

The cap 11 is formed with a flange 11a in the outer end (the outer side of the high-pressure tank 1 in the axial direction) and an annular recess 11b with respect to the axis of the high-pressure tank 1 behind the flange 11a (the inner side of the high-pressure tank 1 in the axial direction), for example. The recess 11b is curved, and projected to the axial side. A portion close to the tip of the CFRP layer 21, which is also rounded, contacts with this recess 11b in an airtight manner.

A solid lubricant coating “C” such as, for example, a fluorinated resin, may be applied to the surface of the recess 11b. Consequently, the friction coefficient between the CFRP layer 21 and the recess 11b is reduced.

The further rear side of the recess 11b of the cap 11 (the inner side of the high-pressure tank 1 in the axial direction) is formed to fit into the shape of the folded portion 30 of the resin liner 20, for example. For example, a projection 11c that is continuous with the recess 11b is formed in a large diameter, and a cap cylindrical portion 11d with a constant diameter is formed in the rear side of the projection 11c. The radius reduction portion 30a in the folded portion 30 of the resin liner 20 tightly contacts with the surface of the projection 11c, and the cylindrical portion 30b tightly contacts with the surface of the cap cylindrical portion 11d. Sealing members 40 and 41 are interposed between the cylindrical portion 30b and the cap cylindrical portion 11d.

The inner peripheral surface of the, cap 11 is formed with a thread 42 on which the valve assembly 50 is screwed to. The valve assembly 50 controls supply and discharge of the fuel gas between an external gas supply line (the supply passage 22) and the inside of high-pressure tank 1. Sealing members 60 and 61 are interposed between the outer peripheral surface of the valve assembly 50 and the inner peripheral surface of the cap 11.

The CFRP layer 21 is formed by Filament Winding molding (FW molding), for example, such that a reinforced fiber sheet that is impregnated with resin is wound over the outer peripheral surface of the resin liner 20 and the recess 11b of the cap 11 and that the resin is hardened thereafter. Examples of the resin used for the CFRP layer 21 include epoxy resin, modified epoxy resin, and unsaturated polyester resin, for example. As the reinforced fiber, carbon fiber, metal fiber, or the like may be used.

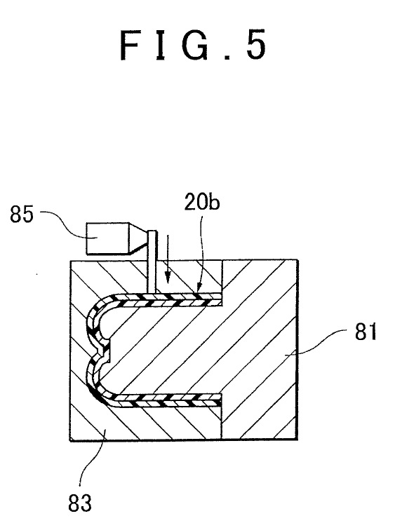

A resin liner 20 that constitutes a high-pressure tank 1 in this embodiment has a two-layer structure in which a gas barrier layer that is formed from ethylene-vinyl alcohol copolymer (EVOH) resin is formed on the outer peripheral surface (a CFRP layer 21 side) of the liner (see FIG. 5). Because EVOH is a resin material that resists gas permeation, it is possible to prevent hydrogen gas in the high-pressure tank 1 from permeating through the resin liner 20.

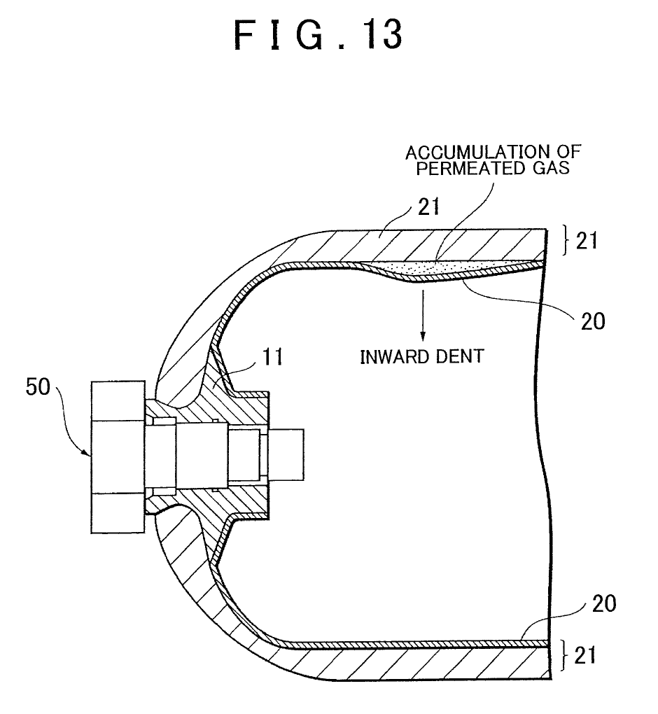

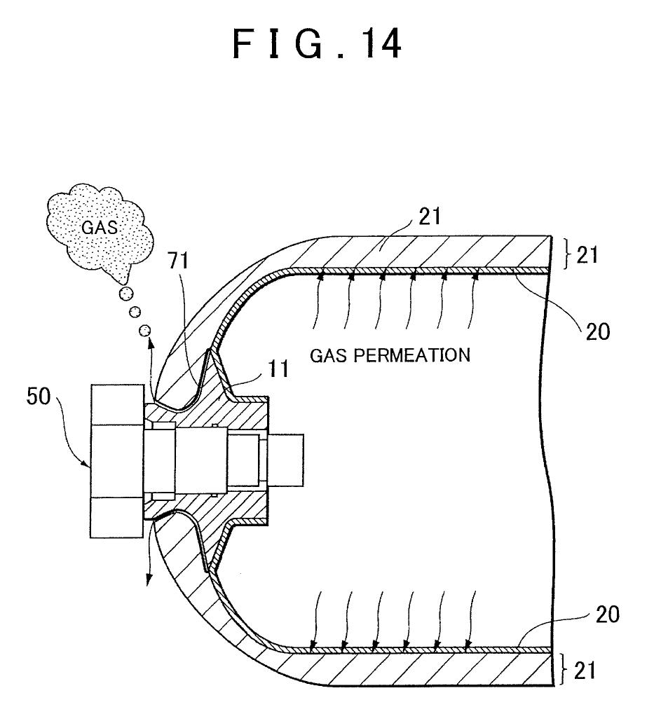

In contrast, in the case of a high-pressure tank that is constructed only from the resin liner 20 and the CFRP layer 21, hydrogen gas that has permeated through the resin liner 20 accumulates in a space between the resin liner 20 and the outer reinforced layer (the CFRP layer 21 in this embodiment), which may cause the resin liner 20 to buckle inwards during discharge of hydrogen gas (see FIG. 12A and FIG. 12B). The resin liner 20 that has been deformed during discharge of hydrogen gas as described above returns to its original shape when the cylinder is refilled with pressurized hydrogen gas. Then, when hydrogen gas is discharged again, the resin liner 20 buckles inward again. Repeated buckling of the resin liner 20 may eventually render the resin liner unusable (see FIG. 13). In the case that hydrogen gas is accumulated in the space between the resin liner 20 and the reinforced layer (CFRP layer 21) and that the inside of the high-pressure tank 1 is at high pressure, a space between the CFRP layer 21 and the cap 11 is pressurized and sealed. Thus, hydrogen gas remains accumulated. However, if the internal pressure decreases with use of hydrogen gas and the like, hydrogen gas may leak from the tank through the weakly sealed space between the CFRP layer 21 and the cap 11 (see FIG. 14).

Accordingly, in this embodiment in which the EVOH layer is formed to make the two-layered resin liner 20 as described above, it is possible to prevent hydrogen gas from permeating through the resin liner 20. Generally, mixture of EVOH and liner resin may cause a chemical reaction in which a physical property of the liner may be degraded. However, because the EVOH layer is formed on the outer surface of the resin liner, that is the first layer, to realize the two-layer structure of the embodiment, EVOH and the liner resin do not cause a chemical reaction. In addition, because it is possible to prevent gas permeation without forming a metal layer, there is no detachment of the metal layer under high pressure.

Next, a description will be made on examples of molding processes of the high-pressure tank 1.

### First Example of Molding Processes

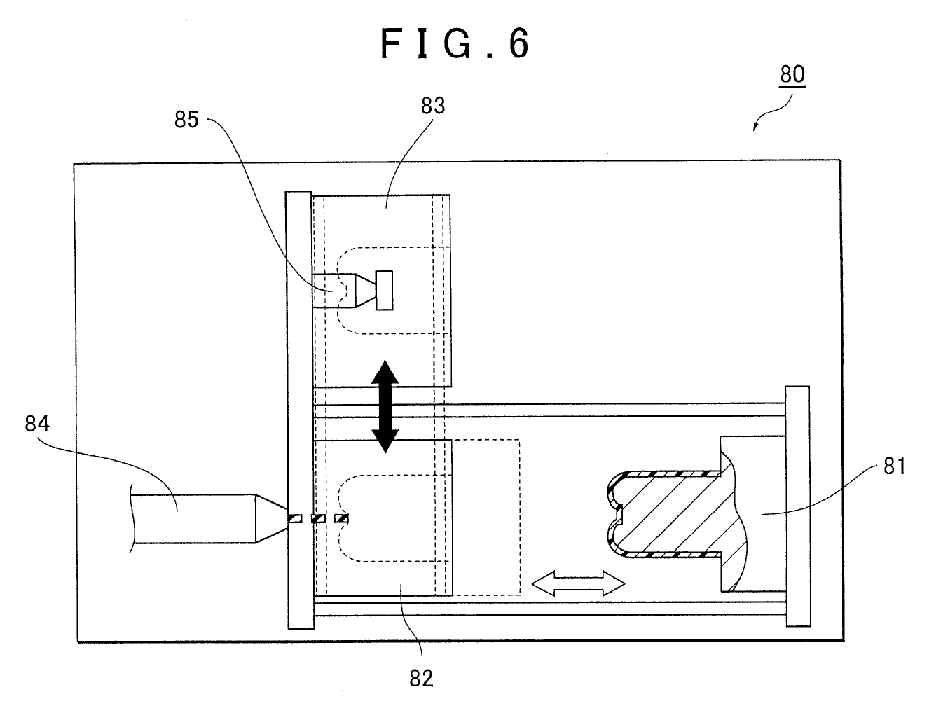

An overview will be provided on manufacturing equipment of the resin liner 20 for the high-pressure tank 1 according to the example of the molding processes (see FIG. 6). This manufacturing equipment 80 includes: a male mold 81 to form the liner; a first female mold 82 that creates a space to form a first layer 20a of the resin liner 20 between the first female mold 82 and the male mold 81; and a second female mold 83 with which the first female mold 82 is replaced after the first layer 20a is formed, and that creates a space to form an EVOH layer 20b on the outer surface of the first layer 20a. The first female mold 82 is provided with an injection molding unit 84 that injects liner resin. The second female mold 83 is provided with an extrusion molding unit 85 to inject EVOH resin. The first female mold 82 and the second female mold 83 are split molds.

In the manufacturing equipment 80, the male mold 81 is formed to be a movable platen and slides in the longitudinal direction of the two-layered resin liner 20 that is to be formed. The first female mold 82 and the second female mold 83 are arranged in a lateral direction that is perpendicular to the above longitudinal direction, formed to be one unit, and adopted to be slidable in a lateral direction (see the bold arrow in FIG. 6). A detailed description of a mechanism to slide the male mold 81 and the female molds 82 and 83 will be omitted. The mechanism could be any of a known mechanism using a linear motor, linear table, ball screw, linear guide, position sensor, stepping motor, servomotor, or the like.

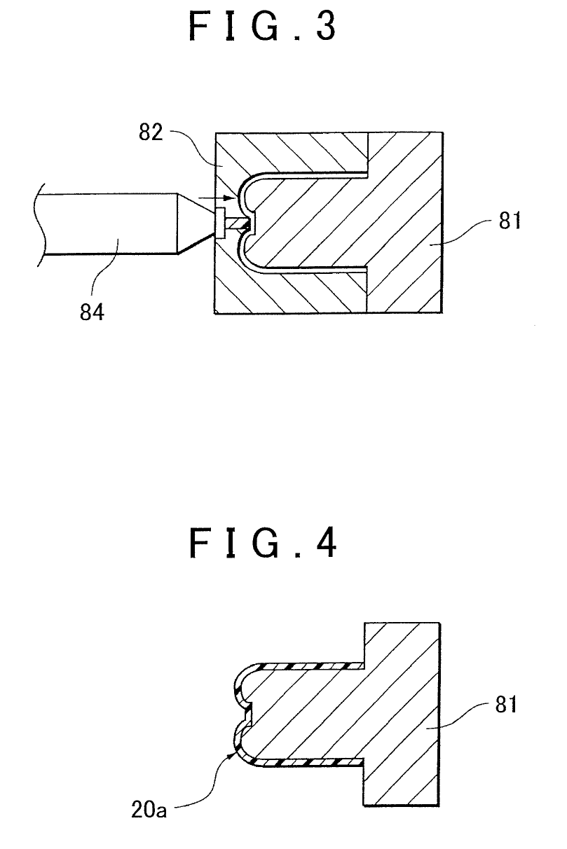

In the manufacturing equipment 80 of the liner for the high-pressure tank as described above, the male mold 81 and the first female mold 82 are first combined. At this time, a space in specified thickness to form the first layer 20a of the resin liner 20 is created between these male mold 81 and female mold 82 (see FIG. 3). A resin material that constitutes the first layer 20a is injected into the space by the injection molding unit 84 at this stage.

The first female mold 82 is opened after the injection molding. At this time, the male mold 81 is pulled back while the first layer 20a remains on the surface of the male mold 81. Then, the female molds 82 and 83 are slid (see FIG. 6) so that the second female mold 83 is placed in front of the male mold 81. Thereafter, when the male mold 81 is advanced and combined with the second female mold 83, a space to form the EVOH layer 20b is created between the first layer 20a and the second female mold 83 (see FIG. 5). That is, the second female mold 83 is bigger than the first female mold 82. The size of this space can appropriately be changed in accordance with desired thickness of the EVOH layer 20b.

At this stage, the EVOH resin material is injected into the space to perform extrusion molding (see FIG. 5). Accordingly, the EVOH layer 20b is formed on the outer surface (surface layer) of the first layer 20a, making the two-layered resin liner 20.

In this case, the mold may be closed during injection of the EVOH resin material. In other words, in the case where the second female mold 83 is closed and combined with the male mold 81, if the second female mold 83 is closed during injection of the EVOH resin material, the resin is more likely to spread even on the surface layer of the first layer 20a.

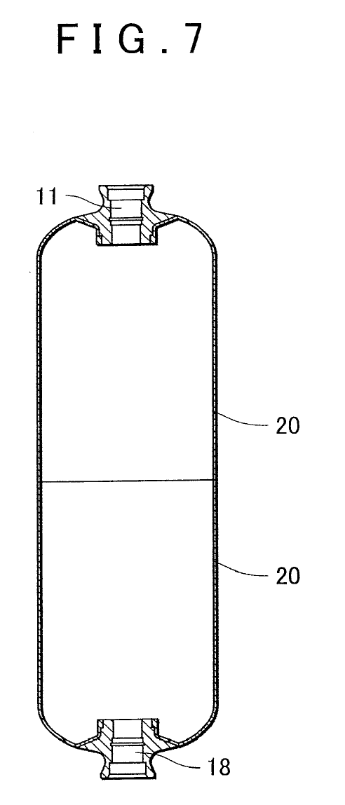

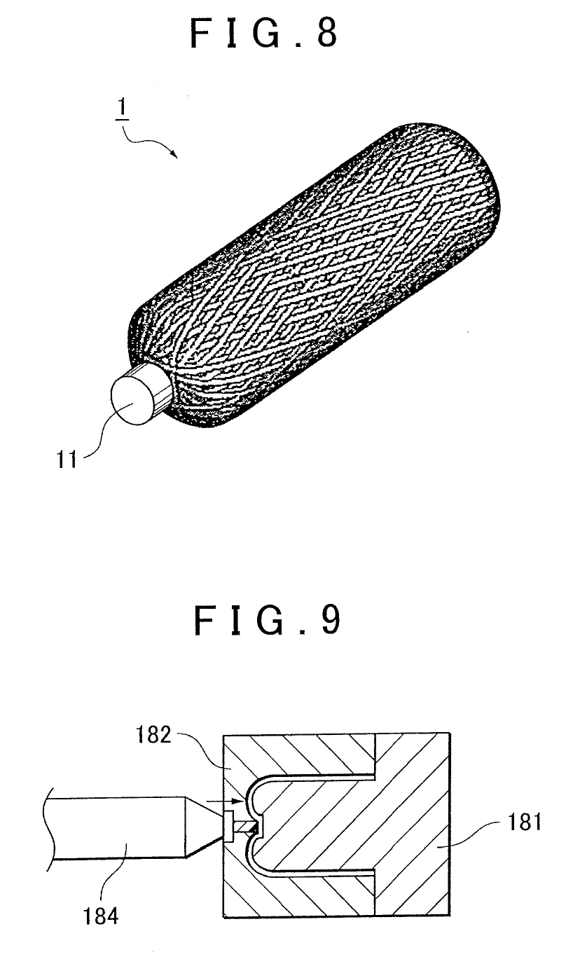

After forming the EVOH layer 20b, the second female mold 83 is opened to release the two-layered resin liner 20. Then, openings of the two resin liners 20 are abutted against and welded to each other. The caps 11 and 18 are assembled (see FIG. 7), and filament winding (FW) molding is performed (see FIG. 8). After the FW molding, the high-pressure tank 1 is heated and hardened so as to obtain a finished product.

According to this example of the molding processes, it is possible to obtain the high-pressure tank 1 that includes the two-layered resin liner 20 in which the EVOH layer 20b is formed on the outer surface (surface layer) of the first layer 20a. Such a high-pressure tank 1 has a high anti-gas permeation property, and prevents permeation of hydrogen gas through the resin liner 20 and accumulation of hydrogen gas between the resin liner 20 and the CFRP layer 21.

In this example of the molding processes, the first layer 20a is not removed from the male mold 81 after the injection molding of the first layer 20a. Then, the male mold 81 is combined with an extrusion mold (the second female mold 83) to form the EVOH layer 20b. Therefore, it is possible to obtain a molded product with accurate dimensions and a superior sealing property between the resins. Particularly, if the first layer 20a shrinks after forming, it is difficult to stabilize the shape. However, according to this embodiment in which the female molds are replaced while the male mold 81 is shared, it is possible to form the EVOH layer 20b in a stabilized shape having equal thickness on the outer surface (surface layer) of the first layer 20a. In addition, by sharing the male mold 81, it is possible to simplify the processes required to form the resin liner 20 of the high-pressure tank 1, to reduce the process time, and further to reduce the cost.

The shape of the second female mold 83 that is used to form the EVOH layer 20b can appropriately be changed in order to obtain EVOH in desired thickness with consideration of a degree of shrinkage of the first layer 20a and the like. Therefore, it is possible with the manufacturing equipment 80 in this embodiment to form the resin liner 20 in the uniform thickness, shape, and quality.

### Second Example of Molding Processes

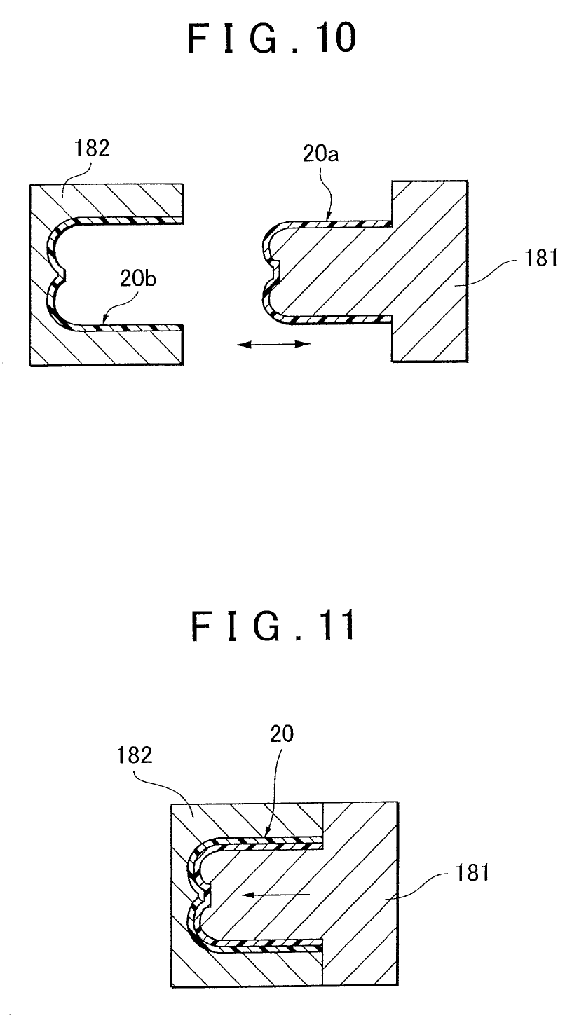

A male mold 181 and a female mold 182 are first combined, and then a resin material that constitutes the first layer 20a is injected by an injection molding unit 184 (see FIG. 9). After the injection molding, the female mold 182 is opened, and the male mold 181 whose surface remains to be formed with the first layer 20a is temporarily pulled back. Meanwhile, the resin film (or a resin sheet) 20b that is made of EVOH and formed in the specified shape by extrusion molding or the like is set in the female mold 182 (see FIG. 10). This resin film 20b can be formed in advance by separately performing the extrusion molding, for example. The resin film 20b can be set in advance in the female mold 182. In addition, this resin film 20b may be set not in the female mold 182 but on the outer surface (surface layer) of the first layer 20a on the male mold 181. In this case, a binder made of epoxy resin and the like may be applied onto the surface of the first layer 20a, if necessary.

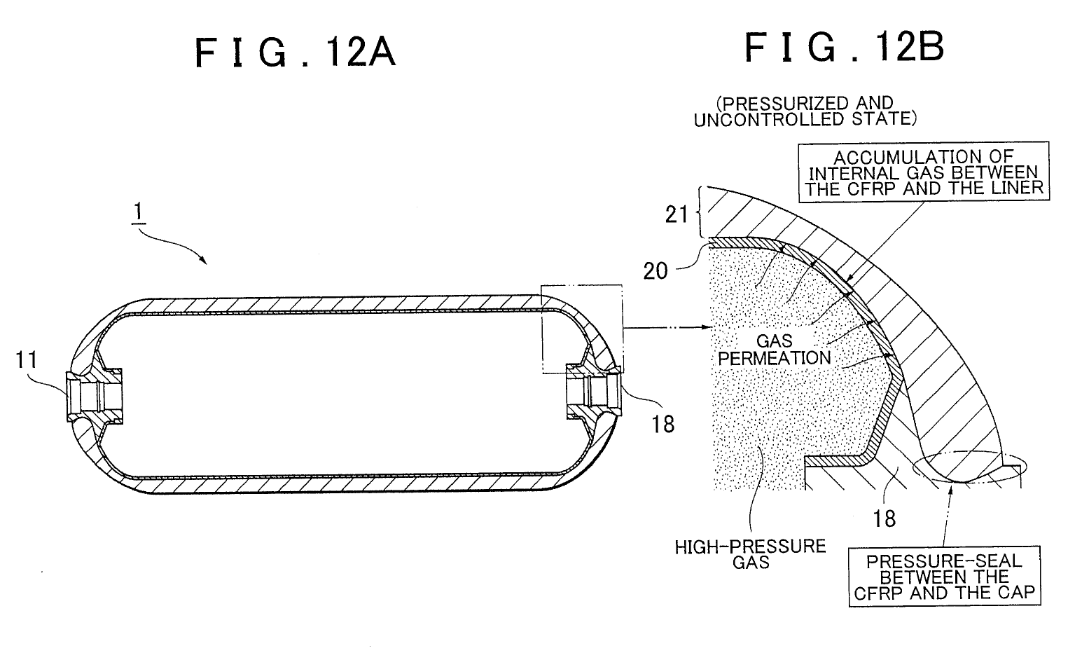

Next, the female mold 182 is closed again to perform pressure molding (a type of film insert molding) (see FIG. 11). Accordingly, the resin film 20b made of EVOH is integrated with the outer surface (surface layer) of the first layer 20a of the resin liner 20. Consequently, the two-layered resin liner 20 can be obtained.

The female mold 182 is opened to release the resin liner 20 after forming the resin film 20b. Then, openings of the two resin liners 20 are abutted against and welded to each other. The cap 11 is assembled (see FIG. 7), and filament winding (FW) molding is performed (see FIG. 8). After the FW molding, the high-pressure tank 1 is heated and cured so as to obtain a finished product.

Also in this example of the molding processes, it is possible to obtain the high-pressure tank 1 that includes the two-layered resin liner 20 in which the EVOH layer 20b is formed on the outer surface (surface layer) of the first layer 20a. This high-pressure tank 1 also has a high anti-gas permeation property, and prevents the permeation of hydrogen gas through the resin liner 20 and the accumulation of hydrogen gas between the resin liner 20 and the CFRP layer 21.

In this second example of the molding processes, the resin film 20b may be placed to the inside of the female mold 182, for example, and so-called film insert molding to inject and form resin may be performed to obtain the two-layered resin liner 20.

The above examples are embodiments of the present invention. Therefore, the above examples are not limited thereto. For example, in each example of the above molding processes, the EVOH layer 20b is formed on the outer surface (surface layer) of the first layer 20a of the liner. However, on the contrary, this EVOH layer 20b may be formed on the inner surface (inside) of the first layer 20a. Although it is not shown in the drawings, in the above second example of the molding processes, the first layer 20a may be temporarily removed from the male mold 182, and the resin film (or resinous sheet) 20b that is made of EVOH resin may be set on the inside of the first layer 20a in order to form the two-layered resin liner 20 in which the EVOH layer 20b is located on the inside. In addition, it is also possible to form the EVOH layer 20b on both the outer surface and the inner surface of the first layer 20a.

In the above first example of the forming processes, the description has been made in the case where the first layer 20a of the resin liner 20 is formed by the injection molding and where the EVOH layer 20b is formed by the extrusion molding. However, they are merely examples, and the EVOH layer 20b can be formed by the injection molding, for example.

In the above first example of the molding processes, the male mold 81 in the manufacturing equipment 80 of the liner for the high-pressure tank can slide in the longitudinal direction while the female molds 82 and 83 in the manufacturing equipment 80 can slide in the lateral direction. However, the above molds can make movement in different directions (for example, the male mold 81 slides in the lateral direction while the female molds 82 and 83 slide in the longitudinal direction, or only the male mold 81 slides in two perpendicular directions). In short, the manufacturing equipment 80 only needs to be constructed such that the male mold 81 and the female molds 82 and 83 can make relative movement with respect to each other so as to allow replacement of the first female mold 82 with the second female mold 83 with respect to the male mold 81.

In the above embodiment, a the high-pressure tank 1 for storing hydrogen that is used as a fuel supply source in the fuel cell system 100 has been described. However, the embodiment is merely one example of the present invention. Therefore, the high-pressure tank 1 according to the present invention may also be used to store gases other than hydrogen gas.

The description has been made so far by exemplifying the component indicated by the numeral 11 as the cap. However, the cap in the present invention is not limited to the one to which the valve assembly 50 is attached. In other words, if a boss is provided on the opposite side of the high-pressure tank 1 from the valve assembly 50, a cap to which the boss is attached may also be considered as the cap of the present invention. In FIG. 7 and FIG. 12, the cap to which the boss is attached is indicated by the reference numeral 18.

In the above embodiments, the description has been made in the case where the gas barrier layer that is constructed from the EVOH layer 20b is formed on the outer surface of the first layer 20a of the resin liner 20. However, the EVOH material is merely an example. Other than the EVOH the gas barrier layer can be formed by using a material with a specified degree of gas permeation coefficient (hydrogen gas permeation coefficient), such as a high-polymer material in which vinyl chloride, for example, is polymerized, and highly cross-linked resin (resin with a higher degree of cross linkage than standard cross-linked resin).

In the above invention, the gas barrier layer may be formed from an ethylene-vinyl alcohol copolymer (EVOH) resin material, a high-polymer material such as vinyl chloride, or highly cross-linked resin, for example.

The high-pressure tank may be filled with hydrogen gas for a fuel cell, for example.

In the above invention, the second female mold may create a larger space between the second female mold and the male mold than the space between the first female mold and the male mold.

In this case, a space to form the EVOH layer is formed between the first layer of the liner and the second female mold after the first layer of the liner is formed.

In the above invention, the first female mold and the second female mold may be arranged in parallel. The first female mold, the second female mold, and the male mold may make a relative movement with respect to each other in a lateral direction.

According to the above invention, the relative movement of the male mold that is covered with the first layer of the liner allows quick replacement of the first female mold with the second female mold.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

What is claimed is:

1. A high-pressure tank comprising:
a cap;
a liner; and
a reinforced layer that is provided on the liner,
wherein the liner includes a gas barrier layer.

2. The high-pressure tank according to claim 1, wherein the gas barrier layer is formed on at least one of the outer surface and the inner surface of the liner.

3. The high-pressure tank according to claim 1, wherein the liner includes a first layer that is formed from a material different from the gas barrier layer.

4. The high-pressure tank according to claim 3, wherein the first layer is formed from polyethylene resin or polypropylene resin.

5. The high-pressure tank according to claim 1, wherein the high-pressure tank is filled with hydrogen gas for a fuel cell.

6. The high-pressure tank according to claim 5, wherein the high-pressure tank is a hydrogen tank as a fuel supply source in a fuel cell system.

7. The high-pressure tank according to claim 1, wherein the gas barrier layer is formed from an EVOH resin material.

8. The high-pressure tank according to claim 1, wherein the gas barrier layer is formed from a high-polymer material in which vinyl chloride is polymerized, or a highly cross-linked resin.

9. A method of manufacturing a high-pressure tank, the method comprising:
injecting resin into a forming mold that includes a male mold and a first female mold, and forming a first layer of a liner;
removing the first female mold to replace it with a second female mold and injecting resin with a gas barrier property to form a gas barrier layer on the outer surface of the first layer so as to make a two-layer structure;
welding the liners to each other after the two-layered liner is release from the mold; and
heating and curing the welded liners after filament winding molding.

10. The method manufacturing the high-pressure tank according to claim 9, wherein the second female mold is bigger than the first female mold.

11. The method of manufacturing the high-pressure tank according to claim 9, wherein the first layer remains in the male mold when the first female mold is removed and replaced with the second female mold.

12. The high-pressure tank according to claim 9, wherein an EVOH resin material is used as the resin with the gas barrier property.

13. The method of manufacturing the high-pressure tank according to claim 9, wherein, when the first female mold is removed and replaced with the second female mold, the resin with the gas barrier property is injected while the second female mold is combined with the male mold.

14. A method of manufacturing a high-pressure tank, the method comprising:
forming a resin film that is made of a resin material with a gas barrier property into a specified shape in advance;
injecting resin into a forming mold that includes a male mold and a female mold, and forming a first layer of a liner;
placing the resin film to either an inside of the female mold or an outer surface of the first layer after the male mold and the female mold are separated;
forming a gas barrier layer on the outer surface of the first layer by film insert molding so as to make a two-layer structure; and
welding the liners to each other after the two-layered liner is released from the mold, and heating and curing the welded liners after filament winding molding.

15. The method of manufacturing the high-pressure tank according to claim 14, wherein an EVOH resin material is used as the resin material with the gas barrier property.

16. The method of manufacturing the high-pressure tank according to claim 14, wherein, when the resin film that is made of the resin material with the gas barrier property is formed into the specified shape in advance, a binder is applied onto the resin film.

17. Manufacturing equipment of a liner for a high-pressure tank, the manufacturing equipment comprising:
a male mold to form the liner;
a first female mold that creates a space to form a first layer of the liner between the male mold and the first female mold; and
a second female mold with which the first female mold is replaced after the first layer is formed, and that creates a space to form a gas barrier layer on an outer surface of the first layer.

18. The manufacturing equipment of the liner for the high-pressure tank according to claim 17, wherein the second female mold creates a larger space between the male mold and the second female mold than the space between the male mold and the first female mold.

19. The manufacturing equipment of the liner for the high-pressure tank according to claim 17, wherein
the first female mold and the second female mold are arranged in parallel; and
the first female mold, the second female mold, and the male mold can make a relative movement with respect to each other in a lateral direction.

20. The manufacturing equipment of the liner for the high-pressure tank according to claim 17, wherein
the first female mold is provided with an injection molding unit that injects liner resin to form the first layer; and
the second female mold is provided with an extrusion molding unit that injects EVOH resin to form the gas barrier layer.
